(19) United States
(12) Patent Application Publication
(10) Pub. No.: US 2024/0205735 A1
(43) Pub. Date: Jun. 20, 2024

(54) METHODS FOR UPLINK TRANSMISSION, RELATED WIRELESS DEVICES AND RELATED NETWORK NODES

(71) Applicant: Sony Group Corporation, Tokyo (JP)

(72) Inventors: Peter ISBERG, Lund (SE); Rickard LJUNG, Helsingborg (SE); Ola CEDELL, Malmö (SE); Rui NUNES, Lund (SE); Adnan PRLJA, Malmö (SE)

(21) Appl. No.: 18/288,084

(22) PCT Filed: Apr. 7, 2022
(86) PCT No.: PCT/EP2022/059269

§ 371 Date: Oct. 24, 2023

(30) Foreign Application Priority Data
May 12, 2021 (SE) 2150602-7

(51) Int. Cl. H04W 28/02; H04W 72/0446; H04W 72/21; H04W 72/563

(52) U.S. Cl. CPC H04W 28/0278; H04W 72/0446; H04W 72/21; H04W 72/563

(57) ABSTRACT

Disclosed is a method, performed by a wireless device, for uplink transmission to a network node. The method comprises transmitting, to the network node, a buffer status report. The buffer status report may comprise first information indicative of an amount of data in a buffer of the wireless device. The buffer status report comprises second information further qualifying the data in the buffer. The method comprises receiving, from the network node, control signalling indicative of an allocation of a resource for uplink transmission of the data.

### TECHNICAL FIELD

The present disclosure pertains to the field of wireless communications. The present disclosure relates to methods for uplink transmission, related wireless devices and related network nodes.

### BACKGROUND

In practical testing of uplink data transmission (such as uplink video transmission) over 5th generation mobile network, 5G, it has been noted that the latency sometimes exceeds expected values. Before the cell reaches its maximum capacity, some packets wait a long time before they are transmitted to the network node (such as gNB).

It has also been noted that with bursty traffic, allocation of resources can get out of synchronization with the uplink traffic pattern.

There is thus need for improvement of the support to uplink data transmission.

### SUMMARY

The latency issue may be due to radio access network, RAN, scheduling that in certain cases allocates more uplink resources to wireless devices (such as User Equipment, UEs) currently active with data transmissions, than the wireless devices have requested. Resources allocated to one wireless device are not available to any other wireless device in the cell. Hence, over-allocating resources to a wireless device blocks resources for other wireless devices and leads to longer delays in accessing a resource for the other wireless devices within the cell.

Accordingly, there is a need for devices and methods for uplink transmission to a network node, which can mitigate, alleviate or address the shortcomings existing and provide an improved resource allocation and support to uplink data transmission.

Disclosed is a method, performed by a wireless device, for uplink transmission to a network node. The method comprises transmitting, to the network node, a buffer status report. The buffer status report may comprise first information indicative of an amount of data in a buffer of the wireless device. The buffer status report comprises second information qualifying (optionally further qualifying) the data in the buffer. The method comprises receiving, from the network node, control signalling indicative of an allocation of a resource for uplink transmission of the data

Further, a wireless device is provided. The wireless device comprises memory circuitry, processor circuitry, and a wireless interface. The wireless device is configured to transmit, via the wireless interface, to the network node, a buffer status report. The buffer status report may comprise first information indicative of an amount of data in a buffer of the wireless device. The buffer status report comprises second information qualifying (optionally further qualifying) the data in the buffer. The wireless device is configured to receive, via the wireless interface, from the network node, control signalling indicative of an allocation of a resource for uplink transmission of the data.

The disclosed wireless device and related method allow for an improved support to uplink transmissions. This may lead to an improved Quality of Service, QoS, for the uplink transmissions, such as for media transmission and/or for video transmission and/or for transmission of data related to gaming. The disclosed wireless device and related method provide information (possibly more precise information, and/or possibly richer information) regarding data in the buffer at the wireless device, thereby permitting the network node to consider such information in resource allocations. The method may provide more information on relation between different data within the wireless device.

Disclosed is a method, performed by a network node, for uplink scheduling. The method comprises receiving, from a wireless device, a buffer status report. The buffer status report may comprise first information indicative of an amount of data in a buffer of the wireless device. The buffer status report comprises second information qualifying (optionally further qualifying) the data in the buffer. The method comprises transmitting, based on the buffer status report, control signalling indicative of an allocation of a resource for uplink transmission of the data.

Further, a network node is provided. The network node comprises memory circuitry, processor circuitry, and a wireless interface. The network node is configured to receive, via the wireless interface, from a wireless device, a buffer status report comprising first information indicative of an amount of data in a buffer of the wireless device. The buffer status report comprises second information further qualifying the data in the buffer. The network node is configured to transmit, via the wireless interface, based on the buffer status report, control signalling indicative of an allocation of a resource for uplink transmission of the data.

The disclosed network node and related method benefit from obtaining information (possibly more precise) regarding data in the buffer at the wireless device. This may improve the resource allocation at the network node. It may be appreciated that the disclosed network node can perform a more proactive and precise scheduling of uplink traffic. The disclosed network node may perform resource allocation for uplink traffic taking data transmission latency requirements into account. This may lead to resource allocation that may support QoS requirements of the uplink transmission while reducing the likelihood of over-allocating resources. In other words, the disclosed network node can allocate resources more proactively such that resources are not wasted, while a throughput may be increased and latency-critical packets can reach their destination in time.

The disclosed technique may lead to an overall optimization of the resource allocation and/or of the resource utilization in a cell.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is signalling diagram illustrating an example communication between an example wireless device and an example network node according to this disclosure,

FIG. 3 is a flow-chart illustrating an example method, performed in a wireless device, for an uplink transmission to a network node according to this disclosure,

FIG. 4 is a flow-chart illustrating an example method, performed in a network node of a wireless communication system, for uplink scheduling according to this disclosure,

FIG. 5 is a block diagram illustrating an example wireless device according to this disclosure,

FIG. 6 is a block diagram illustrating an example network node according to this disclosure, and

FIGS. 7A-D are signalling diagrams illustrating example communications between an example wireless device and an example network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

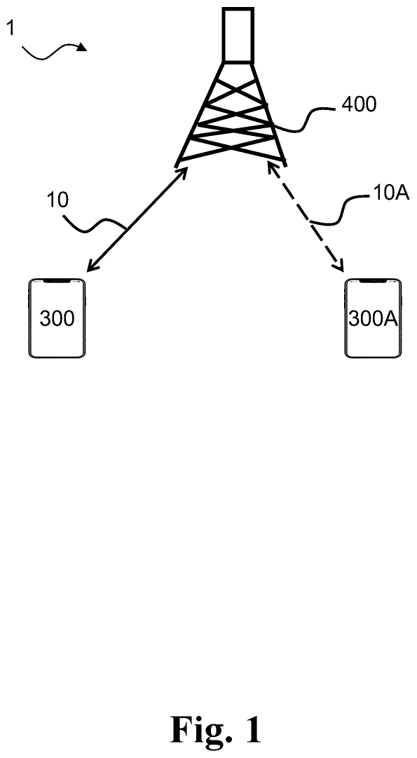

FIG. 1 is a diagram illustrating an example wireless communication system 1 comprising an example network node 400 and an example wireless device 300 according to this disclosure.

As discussed in detail herein, the present disclosure relates to a wireless communication system 1 comprising a cellular system, for example, a 3^{rd} Generation Partnership Project, 3GPP, wireless communication system, such as a 5G system. The wireless communication system 1 comprises a wireless device 300 and/or a network node 400.

A network node disclosed herein refers to a radio access network, RAN, node operating in the radio access network, such as a base station, an evolved Node B, eNB, gNB in NR. In one or more examples, the RAN node is a functional unit which may be distributed in several physical units.

The wireless communication system 1 may comprise a core network node. A core network, CN, node may be seen a network node operating in the core network, such as in the Evolved Packet Core Network, EPC, and/or a 5G Core Network, 5GC. Examples of CN nodes in EPC include a Mobility Management Entity, MME.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment, UE.

The wireless device 300, 300A may be configured to communicate with the network node 400 via a wireless link (or radio access link) 10, 10A.

Over-allocating resources to a wireless device (such as wireless device 300) blocks resources for other wireless devices (such as wireless device 300A) and may lead to longer delays in accessing resources for the other wireless devices (such as wireless device 300A). For example, some allocated resources may be likely not to be utilized for meaningful data but to be filled with padding data. The result may be that the wireless device (such as wireless device 300) which receives over-allocation of resources is given very good opportunities to transmit its data, while other wireless devices (such as wireless device 300A) not yet scheduled will experience longer delays when requesting resources for transmissions. The network node 400 (such as a scheduler of the network node 400) may be over-allocating resources to wireless device 300 for optimizing results on ping tests for the already active wireless devices in the cell. For example, the active wireless devices can answer a ping very quickly via the already allocated uplink, UL, resources. The present disclosure can reduce the likelihood of over-allocating resources by improving the buffer status reporting.

With bursty traffic, the allocation of resources can get out of synchronization with the traffic pattern. For example, with video using for example H.264 or H.265 codecs, there are I-frames, P-frames, and B-frames where the I-frame is the largest in size and also most important as it constitutes the baseline for several frames (in Group of Pictures, GOP structure). For example, the amount of data to be transmitted increases every time an I-frame appears, and the allocation of resources has to be increased accordingly. For example, a short time later, the I-frame is fully transmitted, and the allocation to the specific wireless device could quickly be decreased to free up resources for other wireless devices in the cell. However, the network node may likely be a step behind and may not stay fully in synchronization with the traffic pattern, thereby resulting in wasted resources. For example, 2-5 ms delay from requesting a resource until a grant is received has been observed. The disclosed technique addresses, inter alia, this challenge and provides an improved support for bursty traffic.

For example, in an uplink video streaming for professional production, the data rates may be high (for production quality) and the latency can be critical (for example, due to using a mix of wired and wireless cameras that should stay in synchronization, and/or due to the need of round-trip feedback to camera operators). The present disclosure provides a technique that allows the network node to be aware that there are, for example, latency-critical packets to be handled, while reducing (or even avoiding in some cases) wasting resources.

The present disclosure may be seen as expanding a transmit buffer status reporting to include information qualifying data in the buffer of the wireless device.

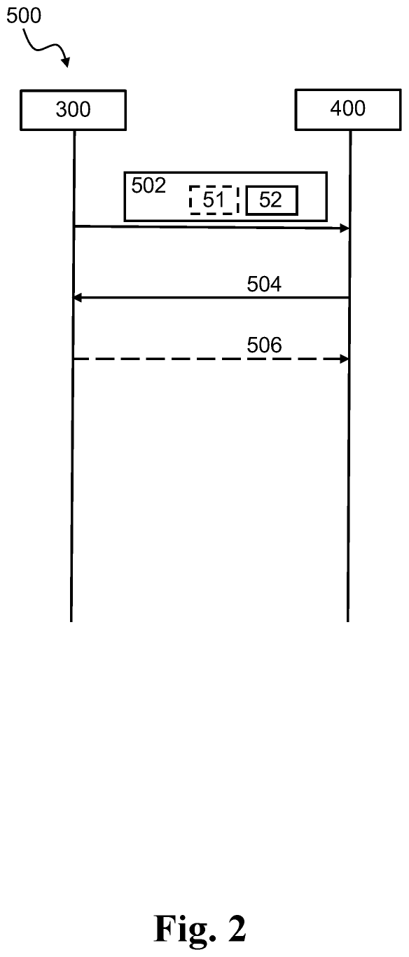

FIG. 2 is a signalling diagram 500 illustrating an example communication between an example wireless device 300 and an example network node 400 according to this disclosure.

The wireless device 300 comprises a buffer (such as a transmit buffer, such as a modem transmit buffer) configured to buffer data for uplink transmission. The buffer may be seen as a data buffer configured to store data temporarily in a part of the memory circuitry of the wireless device until transmission. For example, the data buffered may comprise data coming from an upper layer, such as a layer above physical layer, such as application layer.

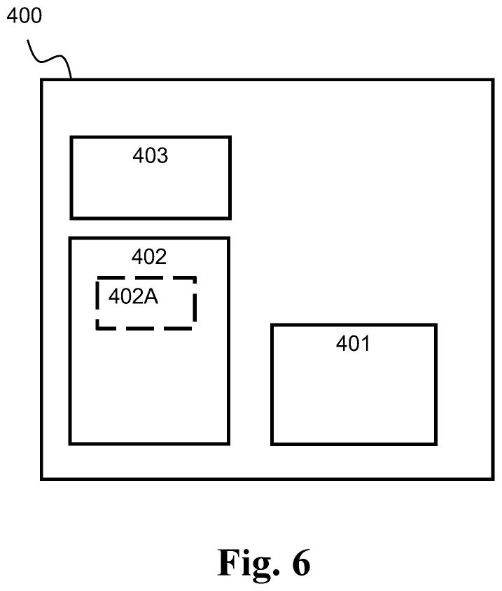

The wireless device 300 is configured to transmit a buffer status report 502 to the network node 400. Transmission of the buffer status report 502 may be based on a configuration from the network (such as for periodic or aperiodic transmission, timing where the wireless device is allowed to send the buffer status report). A buffer status report may be seen as Medium Access Control, MAC control element, such as in 3GPP TS 38.321, FIG. 6.1.2.1-1/2.

The buffer status report 502 may include first information 51. The first information may be indicative of an amount of data in the buffer of the wireless device 300. For example the first information may comprise a buffer status parameter indicating the amount of data in the buffer, such as a buffer status value and/or a buffer level value. For example, there may be a plurality of data packets in the buffer, and the first information may indicate the total amount of data in the buffer based on the amount of data in each data packets.

The buffer status report 502 may comprise second information 52. The second information 52 is configured to qualify the data in the buffer, for example in other terms than amount of data in the buffer. In other words, the second information may be configured to qualify the data in the buffer by providing information that characterizes the data in the buffer, for example in other terms than amount of data in the buffer. For example, the second information 52 qualifies the data in the buffer, for example in terms of time information and/or relation information between at least two data packets in the buffer. For example, the second information may further qualify the data in the buffer when a buffer status report may have provided the amount of data in the buffer. The second information may be transmitted within the same bit sequence as the first information or as a separate transmission of information bits. In other words, the buffer status report transmission may comprise a first transmission including first information as one transmission and a second transmission including second information. The second transmission may occur at same time as the first transmission (for example, frequency duplexed), or at a different time than the first transmission (for example, time duplexed). The first and second transmission may be part of the same signaling message. The first and second transmission may be part of different signaling messages. The first and second transmission may occur directly after each other. There may be a time gap in between the first and second transmission. The second information may be encapsulated or piggybacked with other information and/or other signaling transmissions. In other words, in some examples, the buffer status report 502 may comprise the first information 51 and/or the second information 52. For example, the second information 52 is different information (such as different type of information) than the first information 51. The transmission frequency of the first and second information may be the same, or it may be different, for example wherein the second information is only transmitted at some specific occasions. Such occasions may define certain QoS requirements and/or other needs for the wireless device to specifically add the second information. Further, the second information may be valid for a single transmission of the first information, or it may be valid for more than one transmission of the first information. The first and second information may pertain to transmissions of signaling on same or different transmission layers. For example, the first information may be included in transmissions at a first layer such as the MAC layer and the second information may be included at a second layer different than the first layer such as a physical layer or a radio resource control (RRC) layer. In some examples, the second information may be included at the first layer.

For example, the second information qualifies the data in the buffer, for example in terms of time information, for example age of at least one data packet in the buffer (such as age of the buffer content) and/or an expiry (such as the time to live) of at least one data packet in the buffer (such as expiry of the buffer content). Age may be seen as a feature indicating elapsed time since the data was produced (for example, since an encoder produced encoded data, and/or since data was packetized, and/or since a camera captured a visual event, and/or since a microphone captured an acoustic event).

For example, the second information qualifies the data in the buffer in terms of relation. For example, Internet Protocol, IP, packets may have a strong relation between each other, such as belonging to the same burst, such as to the same frame, such as to the same video frame. For example, the second information qualifies the data in the buffer, for example in terms of burst information. For example, the second information qualifies the data in the buffer, for example in terms of priority, for example indicating the priority of different parts of data in the buffer, such as I and P/B-frames for video. For example, the second information qualifies the data in the buffer, for example in terms of priority, for example indicating the priority of a wireless device in a group of wireless devices.

In one or more examples, the second information qualifies a timing feature of the data in the buffer, and/or a relation feature between at least two data packets of the plurality of data packets.

The wireless device 300 is configured to receive, from the network node 400, control signalling 504 indicative of an allocation of a resource for uplink transmission of the data.

The wireless device 300 may be configured to transmit, to the network node 400, the data 506 using the resource indicated in the control signalling 504.

The present disclosure can apply to any data transmission, such as transmission of media data, for example, for video and/or gaming.

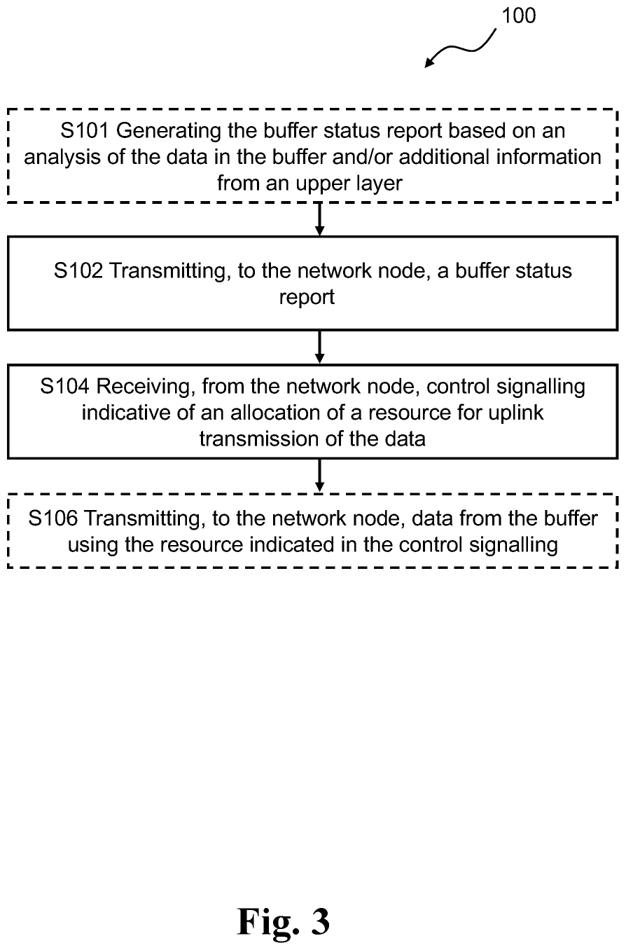

FIG. 3 shows a flow diagram of an example method 100, performed by a wireless device, for uplink transmission to a network node according to the disclosure. The method 100 may be performed by a wireless device disclosed herein, such as wireless device 300 of FIGS. 1, 2, 5 and 7A-D.

The method 100 comprises transmitting S102, to the network node, a buffer status report. The buffer status report may comprise first information indicative of an amount of data in a buffer of the wireless device. In other words, the buffer status report can indicate information about the amount of data available for transmission in the buffer, such as UL buffer(s). The buffer status report may be part of a link layer of the protocol stack at the wireless device, such as Medium Access Control, MAC, layer. For example, the first information may be included in transmissions at a first layer such as the MAC layer.

For example, the first information may comprise a buffer status parameter indicating the amount of data available and/or present in the buffer, such as a buffer status value and/or a buffer level value. For example, there may be a plurality of data packets in the buffer, and the first information may indicate the total amount of data in the buffer based on the amount of data in each data packets.

The buffer status report comprises second information. The second information may be information further qualifying the data in the buffer. In one or more examples, the second information is information qualifying the data in the buffer. In other words, the second information is not seen as information that quantifies the amount of data available in the buffer. For example, the second information may be included in transmissions at a link layer (such as the MAC layer), and/or a physical layer, and/or a radio resource control (RRC) layer. The second information may be encapsulated or piggybacked with other information and/or other signaling transmissions.

In one or more example methods, the buffer status report comprises the first information and/or the second information. For example, the second information is different information (such as different type of information) than the first information.

In one or more example methods, transmitting S102, to the network node, the buffer status report may comprise transmitting the buffer status report comprising the first information separately from the transmission of the second information. In one or more examples, there may be a time gap in between transmission of the first information and transmission of the second transmission.

The method 100 comprises receiving S104, from the network node, control signalling indicative of an allocation of a resource for uplink transmission of the data.

The disclosed wireless device and related method allow for an improved support to uplink transmissions. This may lead to an improved Quality of Service, QoS, for the uplink transmissions, such as for media transmission and/or for video transmission. The disclosed wireless device and related method provide information (possibly more precise) regarding data in the buffer at the wireless device, thereby permitting the network node to consider such information in resource allocations.

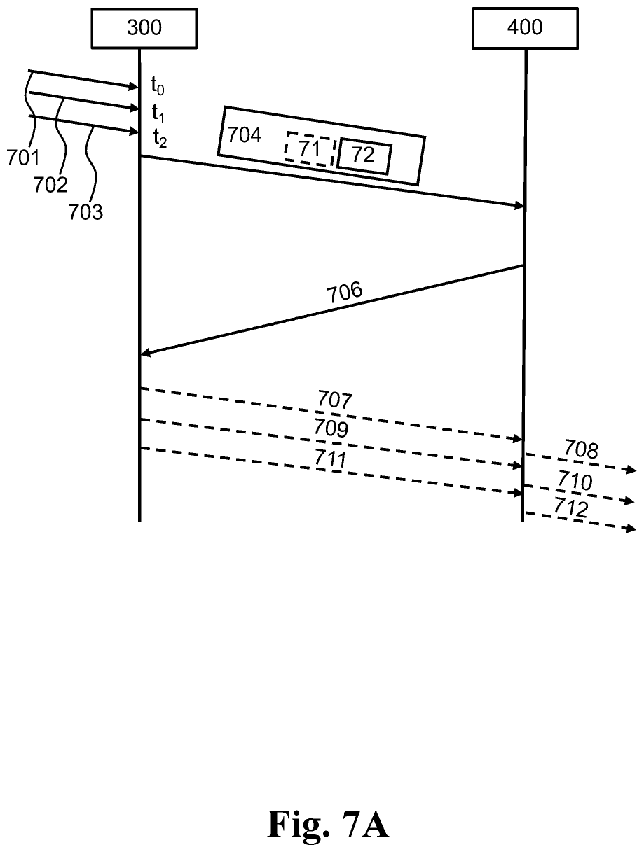

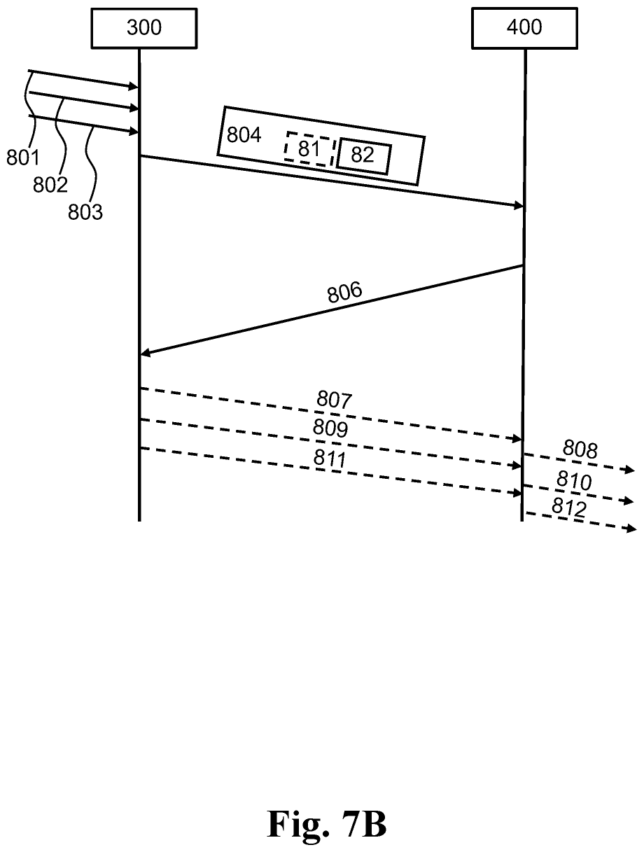

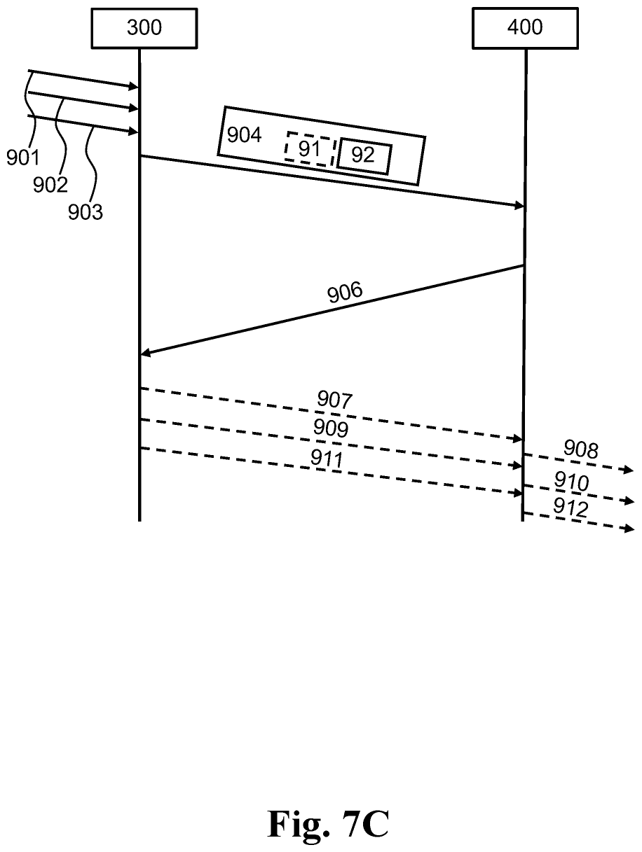

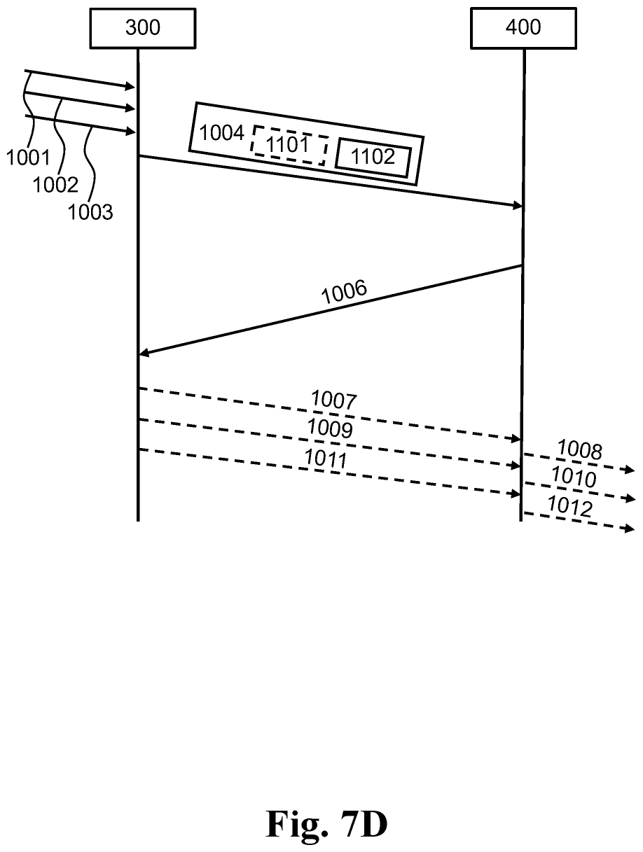

In one or more example methods, the second information comprises time information associated with at least one data packet in the buffer. In one or more example methods, the time information is indicative of an age of the at least one data packet. For example, the age of a data packet may be indicated by a timestamp, such as a timestamp of capture of a corresponding frame and/or a timestamp of encoding of a corresponding frame (as illustrated in FIG. 7A). For example, the age of data (for example age of one or more data packets, such as an aggregated value of the ages of the data packets, such as a maximum value of the ages of the data packets, such as the age of each data packet) in the buffer can be added to the buffer status report. For example, the buffer status can be reported to the network node in terms of both the amount of data, and the age of the data. For example, age can be reported in terms of its maximum, mean and/or minimum values of the data packets in the buffer (for example, at least the maximum value).

In one or more example methods, the time information is indicative of an expiry of the at least one data packet. For example, the expiry may be a Time To Live, TTL. A TTL may be seen as a maximum time a data packet is allowed to remain in the network. TTL may be seen as indicative of age. For example, the Time To Live (TTL) of packets in the buffer can be added to the buffer status report as illustrated in FIG. 7B. For example, the buffer status may be reported to the network node in terms of both the amount of data, and the TTL. For example, TTL may be reported in terms of its maximum, mean and minimum values of the data packets in the buffer (for example, at least the minimum value). It may be appreciated that an explicit TTL information makes the network node directly aware of the packet requirements. For example, the network node does not have to wait until receiving the IP packets, before knowing their TTL. In one or more examples, the TTL from the application to the modem may be given with a microsecond and/or millisecond resolution. It may be noted that TTL is in standard IP headers based on seconds. The disclosed expiry (such as TTL) can provide more freedom for greater resolution than the standard resolution. For example, the application or the application layer can communicate the expiry (such as TTL) to the link layer or modem separately, not utilizing IP headers. The disclosed expiry can then be communicated in the second information, for example by a different means than a standard IP header, to the network node.

In one or more examples, the expiry may be indicated in other form than TTL. For example, the expiry may be indicated by a time parameter that indicates to a RAN node a life expectancy of a data packet.

In one or more example methods, the buffer comprises a plurality of data packets. In one or more example methods, the second information is indicative of a relation between at least two data packets of the plurality of data packets. A relation may be seen as a characteristic that relates a data packet to another data packet. For example, a relation may comprise a time relation, a burst relation, a range relation, and/or a priority relation. The second information may comprise relation data representative of the relation between at least two data packets of the plurality of data packets.

In one or more example methods, the second information comprises burst information indicating at least two data packets belonging to a same burst. A burst information may comprise a range information. For example, burst information may indicate the beginning and end of a burst of IP packets and/or frame. Providing burst information as part of the buffer status report allows to inform the network node as early as possible. For example, the burst information can be provided from the wireless device, for example indicating that a range of data is to be considered as a combined burst of data. For example, when data is coming to a modem of the wireless device from a video encoder of the wireless device, the data within each video frame may be considered as a range of bits or bytes which should be considered as a combined data burst. The burst information may be provided as a set of transport blocks or similar. For example, the burst information may comprise a burst identifier.

In one or more example methods, the second information comprises priority information. For example, the priority information may be in form of a priority indicator.

In one or more example methods, the priority information is indicative of a priority order between at least two data packets, such as a data packet priority order between at least two data packets. For example, the wireless device can indicate relative priorities for different data packets (and/or sets of data packets and/or data sets) within a data transfer. For example, when the data (such as a data packet) is coming to the modem from a video encoder, the data or data packets within I-frames and P-frames are given different priorities. For example, when the data is coming to the modem from several applications, there may be opportunities to prioritized data bursts where all or most of the data bytes are related to a higher QoS demanding service.

In one or more example methods, the priority information is indicative of a priority order of the wireless device in a group of wireless devices, such as a wireless device priority order of the wireless device in a group of wireless devices. The group of wireless devices may or may not be handled by the network node. For example, when the wireless device (for example, on application layer) is aware that there are more than one wireless device involved in a video production session, the second information may indicate individual UE priority. The priority order of the wireless device may for example be provided in video production for prioritizing data coming from a given wireless device over others.

In one or more example methods, the method 100 comprises transmitting S106, to the network node, data from the buffer using the resource indicated in the control signalling (of S104).

In one or more example methods, the method 100 comprises generating S101 the buffer status report and/or second information based on an analysis of the data in the buffer, such as analysis of the buffered packetized data to derive respective ages and/or respective expiries and/or respective relation information. In one or more example methods, the method 100 comprises generating S101 the buffer status report and/or second information based on additional information from an upper layer to derive priority and/or time related information. An upper layer may be a layer higher than a physical layer and/or a MAC layer of a protocol stack at the wireless device.

In one or more example methods, the receiving S104 of the control signalling indicative of the allocation of the resource is performed after the transmission S102 of the buffer status report, as illustrated in FIG. 2 and FIGS. 7A-D. In one or more example methods, the receiving S104 of the control signalling indicative of the allocation of the resource for uplink transmission is performed after the transmission S102 of the buffer status report.

In one or more example methods, the control signalling indicative of the allocation of the resource is based on the transmitted buffer status report. In other words, the network node may take into account the buffer status report including the second information when performing resource allocation for transmission of the uplink data buffered.

In one or more example methods, the control signalling indicative of the allocation of the resource comprises a resource grant indicative of the allocation of the resource for the uplink transmission of the data.

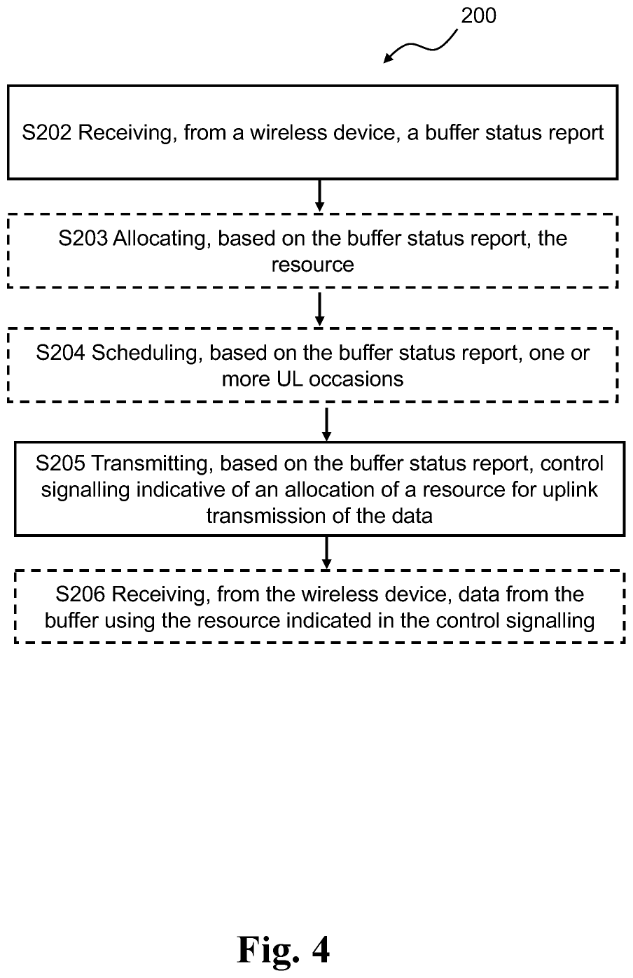

FIG. 4 shows a flow diagram of an example method 200, performed by a network node according to the disclosure. The method 200 may be performed for uplink scheduling and/or resource allocation for uplink communication. The method 200 may be performed by a network node disclosed herein, such as network node 400 of FIGS. 1, 2, 6 and 7A-D.

The method 200 comprises receiving S202, from a wireless device, a buffer status report. The buffer status report may comprise first information indicative of an amount of data in a buffer of the wireless device. For example, the first information may comprise a buffer status parameter indicating the amount of data available and/or present in the buffer, such as a buffer status value and/or a buffer level value. For example, there may be a plurality of data packets in the buffer, and the first information may indicate the total amount of data in the buffer based on the amount of data in each data packets. The step S202 may correspond to S102 of FIG. 3.

The buffer status report comprises second information. The second information may be information further qualifying the data in the buffer. In one or more examples, the second information is information qualifying the data in the buffer. In other words, the second information is not seen as information that quantifies the amount of data available in the buffer.

In one or more example methods, the buffer status report comprises the first information and/or the second information. For example, the second information is different information (such as different type of information) than the first information.

The method 200 comprises transmitting S205, based on the buffer status report (for example by considering the buffer status report, including the second information), control signalling indicative of an allocation of a resource for uplink transmission of the data. The step S205 may correspond to S104 of FIG. 3.

It may be appreciated that the network node can allocate uplink resources to wireless devices by not only considering how much data the wireless devices have to transmit, but also considering whether there is data that is soon to expire, and/or which data packets belong to the same burst (such as video frame), and/or which data packets contain data with higher priority (such as I-frames).

In one or more example methods, the second information comprises time information associated with at least one data packet in the buffer. In one or more example methods, the time information is indicative of an age of the at least one data packet. For example, the age of a data packet may be indicated by a timestamp, such as a timestamp of capture of a corresponding frame and/or a timestamp of encoding of a corresponding frame (as illustrated in FIG. 7A). For example, age can be reported in terms of its maximum, mean and/or minimum values of the data packets in the buffer (for example, at least the maximum value).

In one or more example methods, the time information is indicative of an expiry of the at least one data packet. For example, the expiry may be a Time To Live, TTL. TTL may be seen as indicative of age. For example, TTL may be reported in terms of its maximum, mean and minimum values of the data packets in the buffer (for example, at least the minimum value). It may be appreciated that an explicit TTL information makes the network node directly aware of the packet requirements. For example, the network node does not have to wait until receiving the IP packets, before knowing their TTL. In one or more example, the TTL from the application to the modem may be given with a microsecond and/or millisecond resolution.

In one or more example methods, the buffer comprises a plurality of data packets. In one or more example methods, the second information is indicative of a relation between at least two data packets of the plurality of data packets. For example, a relation may comprise a time relation, a burst relation, a range relation, and/or a priority relation. The second information may comprise relation data representative of the relation between at least two data packets of the plurality of data packets.

In one or more example methods, the second information comprises burst information indicating at least two data packets belonging to a same burst. A burst information may comprise a range information. For example, burst information may indicate the beginning and end of a burst of IP packets and/or frame. Providing burst information as part of the buffer status report allows to inform the network node as early as possible. For example, the burst information can be provided from or by the wireless device, for example indicating that a range of data is to be considered as a combined burst of data. For example, when data is coming to a modem of the wireless device from a video encoder of the wireless device, the data within each video frame may be considered as a range of bits or bytes which should be considered as a combined data burst. The burst information may be provided as a set of transport blocks or similar. For example, the burst information may comprise a burst identifier.

In one or more example methods, the second information comprises priority information. In one or more example methods, the priority information is indicative of a priority order between at least two data packets of the plurality of data packets. For example, the wireless device can indicate relative priorities for different data packets (and/or sets of data packets and/or data sets) within a data transfer. For example, when the data (such as a data packet) is coming to the modem from a video encoder, the data or data packets within I-frames and P-frames are given different priorities. For example, when the data is coming to the modem from several applications, there may be opportunities to prioritized data bursts where all or most of the data bytes are related to a higher QoS demanding service.

In one or more example methods, the priority information is indicative of a priority order of the wireless device in a group of wireless devices. The group of wireless devices may or may not be handled by the network node. For example, when the wireless device (for example, on application layer) is aware that there are more than one wireless device involved in a video production session, the second information may indicate individual UE priority. The priority order of the wireless device may for example be provided in video production for prioritizing data coming from a given wireless device over others. In one or more example methods, the method 200 comprises receiving S206, from the wireless device, data from the buffer using the resource indicated in the control signalling. Step S206 may correspond to S106 of FIG. 3.

In one or more example methods, the control signalling indicative of the allocation of the resource for uplink transmission of the data comprises a resource grant indicative of the resource allocated for the uplink transmission of the data.

In one or more example methods, the method 200 comprises allocating S203, based on the buffer status report, the resource. For example, allocating S203 the resource is performed by taking into account the second information.

In one or more example methods, the method 200 comprises scheduling S204, based on the buffer status report, one or more uplink occasions. For example, allocating S204 the one or more UL occasions is performed by taking into account the second information.

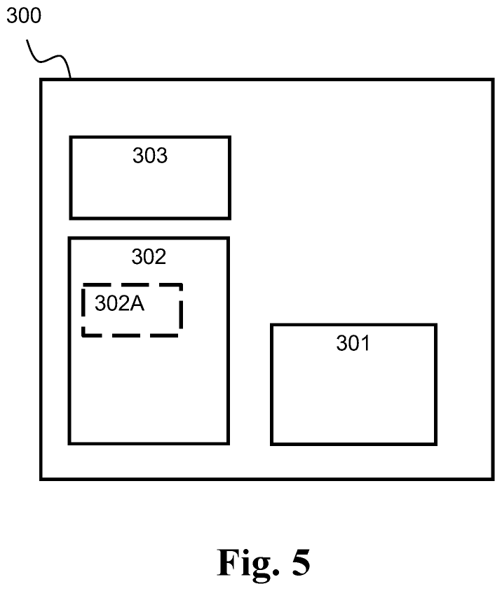

FIG. 5 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 3. In other words, the wireless device 300 may be configured for uplink transmission to a network node.

The wireless interface 303 is configured for wireless communications via a wireless communication system, such as a 3GPP system, such as a 3GPP system supporting one or more of: New Radio, NR, 5G.

The wireless device 300 is configured to transmit, via the wireless interface and/or the processor circuitry (such as via the wireless interface 303 and/or the processor circuitry 302), to the network node, a buffer status report. The buffer status report may comprise first information indicative of an amount of data in a buffer 302A of the wireless device 300. In other words, the wireless device 300 can comprise a buffer 302A to store data in a part of the memory circuitry 301.

In one or more example wireless devices, the buffer status report comprises second information qualifying (optionally further qualifying) the data in the buffer.

The wireless device 300 is configured to receive, via the wireless interface and/or the processor circuitry (such as via the wireless interface 303 and/or the processor circuitry 302), from the network node, control signalling indicative of an allocation of a resource for uplink transmission of the data.

The wireless device 300 is optionally configured to perform any of the operations disclosed in FIG. 3 (such as any one or more of S101, S102, S104, S106). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 5). Memory circuitry 301 is considered a non-transitory computer readable medium.

Memory circuitry 301 may be configured to store second information in a part of the memory.

FIG. 6 shows a block diagram of an example network node 400 according to the disclosure. The network node 400 comprises memory circuitry 401, processor circuitry 402, and a wireless interface 403. The network node 400 may be configured to perform any of the methods disclosed in FIG. 4. In other words, the network node 400 may be configured for uplink scheduling.

The wireless interface 403 is configured for wireless communications via a wireless communication system, such as a 3GPP system, such as a 3GPP system supporting one or more of: New Radio, NR, and 5G.

The network node 400 is configured to receive (such as via the wireless interface 403 and/or the processor circuitry 402), from a wireless device, a buffer status report. The buffer status report comprises first information indicative of an amount of data in a buffer of the wireless device.

The buffer status report comprises second information qualifying (optionally further qualifying) the data in the buffer.

The network node 400 is configured to transmit (such as via the wireless interface 403 and/or the processor circuitry 402), based on the buffer status report, control signalling indicative of an allocation of a resource for uplink transmission of the data.

Processor circuitry 402 may comprise a scheduler 402A configured to allocate resource(s) and schedule communications.

Processor circuitry 402 is optionally configured to perform any of the operations disclosed in FIG. 4 (such as any one or more of S202, S203, S204, S205, S206). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 6). Memory circuitry 401 is considered a non-transitory computer readable medium.

Memory circuitry 401 may be configured to store second information, buffer status report in a part of the memory.

FIGS. 7A-D are signalling diagrams illustrating example communications between an example wireless device 300 and an example network node 400 according to this disclosure.

In FIGS. 7A-7D, the wireless device 300 comprises a buffer (such as a transmit buffer, such as a modem transmit buffer) configured to buffer data for uplink transmission. For example, the data buffered may comprise data coming from an upper layer, such as a layer above physical layer, such as application layer.

In FIG. 7A, data packets 701, 702, 703 arrive in the buffer of the wireless device 300. For example, data packets 701, 702, 703 may form a data burst. In FIG. 7A, data packets 701, 702, 703 may be indicated with respective time information t₀, t₁, t₂. For example the time information may be a timestamp, such as a timestamp of capture and/or encoding of a corresponding frame. The time information can indicate age of the corresponding packet. For example, t₀ may indicate the age of data packet 701. For example, t₁ may indicate the age of data packet 702. For example, t₂ may indicate the age of data packet 703. The wireless device 300 transmits a buffer status report 704 to the network node 400. The buffer status report 704 may include first information 71. The first information 71 may be indicative of an amount of data in the buffer of the wireless device 300. For example the first information 71 may comprise a buffer status parameter indicating the amount of data in the buffer, such as a buffer status value and/or a buffer level value. For example, the first information 71 may indicate the total amount of data in the buffer based on the amount of data in each data packets 701, 702, 703.

The buffer status report 704 may comprise second information 72. The second information 72 is configured to qualify the data in the buffer, for example in other terms than the amount of data in the buffer. For example, the second information 72 qualifies the data in the buffer, for example in terms of time information, such as t₀, t₁, t₂, which may indicate respective ages of the corresponding data packets. For example, in FIG. 7A, the second information 72 comprises an age of at least one data packet amongst 701, 702, 703.

For example, the second information 72 may further qualify the data in the buffer when a buffer status report may have provided the amount of data in the buffer in the first information 71. In other words, in some examples, the buffer status report 704 may comprise the first information 71 and/or the second information 72. For example, the age of data (such as an aggregated value of the ages of the data packets, such as a maximum value of the ages of the data packets, such as the age of each data packet) in the buffer can be added to the buffer status report 704. For example, the buffer status can be reported to the network node in terms of both the amount of data, and the age of the data. For example, age can be reported in terms of its maximum, mean and/or minimum values of the data packets in the buffer (for example, at least the maximum value).

The network node 400 receiving the buffer status report 704 can consider the second information 72 including time information to perform (and possibly improve) the allocation of resources to wireless device 300.

The wireless device 300 receives, from the network node 400, control signalling 706 indicative of the allocation of a resource for uplink transmission of the data. For example, the control signalling 706 may be in form of a resource grant.

The wireless device 300 transmits in 707, 709, 711, to the network node 400, the data packets using the resource indicated in the control signalling 706. The network node 400 can then forward the data packets in 708, 710, 712 to the network.

In FIG. 7B, data packets 801, 802, 803 arrive in the buffer of the wireless device 300. For example, data packets 801, 802, 803 may form a data burst. In FIG. 7B, data packets 801, 802, 803 may be indicated with respective expiries. For example, the expiry may be a Time To Live, TTL. TTL may be seen as indicative of age.

The wireless device 300 transmits a buffer status report 804 to the network node 400. The buffer status report 804 may include first information 81. The first information 81 may be indicative of an amount of data in the buffer of the wireless device 300. For example, the first information 81 may comprise a buffer status parameter indicating the amount of data in the buffer, such as a buffer status value and/or a buffer level value. For example, the first information 81 may indicate the total amount of data in the buffer based on the amount of data in each data packets 801, 802, 803, such as the sum of the data of each data packets.

The buffer status report 804 may comprise second information 82. For example, the second information 82 qualifies the data in the buffer in terms of expiry associated with a data packet. For example, in FIG. 7B, the second information 82 comprises an expiry of at least one data packet amongst 801, 802, 803.

For example, the second information 82 may further qualify the data in the buffer when a buffer status report may have provided the amount of data in the buffer in the first information 81. In other words, in some examples, the buffer status report 804 may comprise the first information 81 and/or the second information 82. For example, the Time To Live (TTL) of packets in the buffer can be added to the buffer status report 804. For example, the buffer status may be reported to the network node in terms of both the amount of data, and the TTL. For example, TTL may be reported in terms of its maximum, mean and minimum values of the data packets in the buffer (for example, at least the minimum value). It may be appreciated that an explicit TTL information makes the network node directly aware of the packet requirements. For example, the network node does not have to wait until receiving the IP packets, before knowing their TTL. In one or more examples, the TTL from the application to the modem may be given with a microsecond and/or millisecond resolution. It may be noted that TTL is in standard IP headers based on seconds. The disclosed TTL can provide more freedom for greater resolution than the standard resolution. For example, the application or the application layer can communicate the disclosed TTL to the link layer or modem separately, not utilizing IP headers. The disclosed TTL can then be communicated in the second information, for example by a different means than a standard IP header to the network node.

The network node 400 receiving the buffer status report 804 can consider the second information 82 including information of expiry of the data packet to perform (and possibly improve) the allocation of resources to wireless device 300.

The wireless device 300 receives, from the network node 400, control signalling 806 indicative of the allocation of a resource for uplink transmission of the data. For example, the control signalling 806 may be in form of a resource grant.

The wireless device 300 transmits in 807, 809, 811, to the network node 400, the data packets using the resource indicated in the control signalling 806. The network node 400 can then forward the data packets 808, 810, 812 to the network.

In FIG. 7C, data packets 901, 902, 903 arrive in the buffer of the wireless device 300. For example, data packets 901, 902, 903 may form a data burst. In FIG. 7C, data packets 901, 902, 903 may be indicated with respective burst information, for example indicating that 901, 902, 903 form part of the same burst. For example, for the network node 400 to know the beginning and end of a burst of IP packets and/or frame as early as possible, the burst information can be provided from the wireless device 300, for example indicating that a range of data is to be considered as a combined burst of data. For example, when data is coming to the modem from a video encoder, the data within each video frame may be considered as a range of bytes which should be considered as a combined data burst. The burst information may be provided as a set of transport blocks or similar. For example, the burst information may comprise a burst identifier.

The wireless device 300 transmits a buffer status report 904 to the network node 400. The buffer status report 904 may include first information 91. The first information 91 may be indicative of an amount of data in the buffer of the wireless device 300. For example the first information 91 may comprise a buffer status parameter indicating the amount of data in the buffer, such as a buffer status value and/or a buffer level value. For example, the first information 91 may indicate the total amount of data in the buffer based on the amount of data in each data packets 901, 902, 903, such as the sum of the data of each data packets.

The buffer status report 904 may comprise second information 92. For example, the second information 92 qualifies the data in the buffer in terms of relation between the data packets, such as burst information. In FIG. 7C, the second information 92 comprises burst information indicating at least two data packets belonging to a same burst.

For example, the second information 92 may further qualify the data in the buffer when a buffer status report may have provided the amount of data in the buffer in the first information 91. In other words, in some examples, the buffer status report 904 may comprise the first information 91 and/or the second information 92.

The network node 400 receiving the buffer status report 904 can consider the second information 92 including burst information to perform (and possibly improve) the allocation of resources to wireless device 300.

The wireless device 300 receives, from the network node 400, control signalling 906 indicative of the allocation of a resource for uplink transmission of the data. For example, the control signalling 906 may be in form a resource grant.

The wireless device 300 transmits in 907, 909, 911, to the network node 400, the data packets using the resource indicated in the control signalling 906. The network node 400 can then forward to the network the data packets in 908, 910, 912 respectively.

In FIG. 7D, data packets 1001, 1002, 1003 arrive in the buffer of the wireless device 300. For example, data packets 1001, 1002, 1003 may form a data burst. In FIG. 7D, data packets 1001, 1002, 1003 may be indicated with respective priority information, for example indicating that 1001, 1002, 1003 form part of the same burst. For example, the priority information may be in form of a priority indicator. For example, the wireless device 300 can indicate relative priorities for different data packets (and/or sets of data packets and/or data sets) within a data transfer. For example, when the data (such as a data packet) is coming to the modem from a video encoder, the data or data packets within I-frames and P-frames are given different priorities. For example, when the data is coming to the modem from several applications, there may be opportunities to prioritized data bursts where all or most of the data bytes are related to a higher QoS demanding service. The wireless device 300 transmits a buffer status report 1004 to the network node 400. The buffer status report 1004 may include first information 1101. The first information 1101 may be indicative of an amount of data in the buffer of the wireless device 300. For example the first information 1101 may comprise a buffer status parameter indicating the amount of data in the buffer, such as a buffer status value and/or a buffer level value. For example, the first information 1101 may indicate the total amount of data in the buffer based on the amount of data in each data packets 1001, 1002, 1003, such as the sum of the data of each data packets.

The buffer status report 1004 may comprise second information 1102. For example, the second information 1102 qualifies the data in the buffer in terms of relation between the data packets, such as priority information. In FIG. 7D, the second information 1102 comprises priority information, such as priority order between at least two data packets and/or priority order of the wireless device 300 in a group of wireless devices. For example, when the wireless device (for example, on application layer) is aware that there are more than one wireless device involved in a video production session, the second information may indicate individual UE priority.

For example, the second information 1102 may further qualify the data in the buffer when a buffer status report may have provided the amount of data in the buffer in the first information 1101. In other words, in some examples, the buffer status report 1004 may comprise the first information 1101 and/or the second information 1102.

The network node 400 receiving the buffer status report 1004 can consider the second information 1102 including priority information to perform (and possibly improve) the allocation of resources to wireless device 300.

The wireless device 300 receives, from the network node 400, control signalling 1006 indicative of the allocation of a resource for uplink transmission of the data. For example, the control signalling 1006 may be in form of a resource grant.

The wireless device 300 transmits in 1007, 1009, 1011, to the network node 400, the data packets using the resource indicated in the control signalling 1006. The network node 400 can then forward to the network the data packets in 1008, 1010, 1012 respectively.

It may be envisaged that in one or more examples, the second information comprises one or more of: age, expiry, relation information, burst information and priority information.

Examples of methods and products (wireless device and network node) according to the disclosure are set out in the following items:

Item 1. A method, performed by a wireless device, for uplink transmission to a network node, the method comprising:
transmitting (S102), to the network node, a buffer status report comprising first information indicative of an amount of data in a buffer of the wireless device;
wherein the buffer status report comprises second information further qualifying the data in the buffer; and
receiving (S104), from the network node, control signalling indicative of an allocation of a resource for uplink transmission of the data.

Item 2. The method according to item 1, wherein the second information comprises time information associated with at least one data packet in the buffer.

Item 3. The method according to item 2, wherein the time information is indicative of an age of the at least one data packet and/or an expiry of the at least one data packet.

Item 4. The method according to any of the previous items, wherein the buffer comprises a plurality of data packets, and wherein the second information is indicative of a relation between at least two data packets of the plurality of data packets.

Item 5. The method according to any of the previous items, wherein the second information comprises burst information indicating at least two data packets belonging to a same burst.

Item 6. The method according to any of the previous items, wherein the second information comprises priority information.

Item 7. The method according to item 6, wherein the priority information is indicative of a priority order between at least two data packets.

Item 8. The method according to any of items 6-7, wherein the priority information is indicative of a priority order of the wireless device in a group of wireless devices.

Item 9. The method according to any of the previous items, the method comprising transmitting (S106), to the network node, data from the buffer using the resource indicated in the control signalling.

Item 10. The method according to any of the previous items, the method comprising generating (S101) the buffer status report based on an analysis of the data in the buffer and/or additional information from an upper layer.

Item 11. The method according to any of the previous items, wherein the receiving (S104) of the control signalling indicative of the allocation of the resource is performed after the transmission (S102) of the buffer status report.

Item 12. The method according to any of the previous items, wherein the control signalling indicative of the allocation of the resource is based on the transmitted buffer status report.

Item 13. The method according to any of the previous items, wherein the control signalling indicative of the allocation of the resource comprises a resource grant indicative of the allocation of the resource for the uplink transmission of the data.

Item 14. A method, performed by a network node, for uplink scheduling, the method comprising:
receiving (S202), from a wireless device, a buffer status report comprising first information indicative of an amount of data in a buffer of the wireless device, wherein the buffer status report comprises second information further qualifying the data in the buffer; and
transmitting (S205), based on the buffer status report, control signalling indicative of an allocation of a resource for uplink transmission of the data.

Item 15. The method according to item 14, wherein the second information comprises time information associated with at least one data packet in the buffer.

Item 16. The method according to item 15, wherein the time information is indicative of an age of the at least one data packet and/or an expiry of the at least one data packet.

Item 17. The method according to any of items 14-16, wherein the buffer comprises a plurality of data packets, and wherein the second information is indicative of a relation between at least two data packets of the plurality of data packets.

Item 18. The method according to any of items 14-17, wherein the second information comprises burst information indicating at least two data packets belonging to a same burst.

Item 19. The method according to any of items 14-18, wherein the second information comprises priority information.

Item 20. The method according to item 19, wherein the priority information is indicative of a priority order between at least two data packets of the plurality of data packets.

Item 21. The method according to any of items 19-20, wherein the priority information is indicative of a priority order of the wireless device in a group of wireless devices.

Item 22. The method according to any of items 14-21, the method comprising receiving (S206), from the wireless device, data from the buffer using the resource indicated in the control signalling.

Item 23. The method according to any of items 14-22, wherein the control signalling indicative of the allocation of the resource for uplink transmission of the data comprises a resource grant indicative of the resource allocated for the uplink transmission of the data.

Item 24. The method according to any of items 14-23, the method comprising allocating (S203), based on the buffer status report, the resource.

Item 25. The method according to any of items 14-24, the method comprising scheduling (S204), based on the buffer status report, one or more uplink occasions.

Item 26. A wireless device comprising memory circuitry, processor circuitry, and a wireless interface, wherein the wireless device is configured to:
transmit, via the wireless interface, to the network node, a buffer status report comprising first information indicative of an amount of data in a buffer of the wireless device;
wherein the buffer status report comprises second information further qualifying the data in the buffer; and
receive, via the wireless interface, from the network node, control signalling indicative of an allocation of a resource for uplink transmission of the data.

Item 27. The wireless device according to item 26, wherein the second information comprises time information associated with at least one data packet in the buffer.

Item 28. The wireless device according to item 27, wherein the time information is indicative of an age of the at least one data packet and/or an expiry of the at least one data packet.

Item 29. The wireless device according to any of items 26-28, wherein the buffer comprises a plurality of data packets, and wherein the second information is indicative of a relation between at least two data packets of the plurality of data packets.

Item 30. The wireless device according to any of items 26-29, wherein the second information comprises burst information indicating at least two data packets belonging to a same burst.

Item 31. The wireless device according to any of items 26-30, wherein the second information comprises priority information.

Item 32. The wireless device according to item 31, wherein the priority information is indicative of a priority order between at least two data packets.

Item 33. The wireless device according to any of items 31-32, wherein the priority information is indicative of a priority order of the wireless device in a group of wireless devices.

Item 34. The wireless device according to any of items 26-33, wherein the processor circuitry is configured to transmit, to the network node, data from the buffer using the resource indicated in the control signalling.

Item 35. The wireless device according to any of items 26-34, wherein the processor circuitry is configured to generate the buffer status report based on an analysis of the data in the buffer and/or additional information from an upper layer.

Item 36. The wireless device according to any of items 26-35, wherein the reception of the control signalling indicative of the allocation of the resource is performed after the transmission of the buffer status report.

Item 37. The wireless device according to any of items 26-36, wherein the control signalling indicative of the allocation of the resource is based on the transmitted buffer status report.

Item 38. The wireless device according to any of items 26-37, wherein the control signalling indicative of the allocation of the resource comprises a resource grant indicative of the allocation of the resource for the uplink transmission of the data.

Item 39. A network node comprising memory circuitry, processor circuitry, and a wireless interface, wherein the network node is configured to:
receive, via the wireless interface, from a wireless device, a buffer status report comprising first information indicative of an amount of data in a buffer of the wireless device, wherein the buffer status report comprises second information further qualifying the data in the buffer; and
transmit, via the wireless interface, based on the buffer status report, control signalling indicative of an allocation of a resource for uplink transmission of the data.

Item 40. The network node according to item 39, wherein the second information comprises time information associated with at least one data packet in the buffer.

Item 41. The network node according to item 40, wherein the time information is indicative of an age of the at least one data packet and/or an expiry of the at least one data packet.

Item 42. The network node according to any of items 39-41, wherein the buffer comprises a plurality of data packets, and wherein the second information is indicative of a relation between at least two data packets of the plurality of data packets.

Item 43. The network node according to any of items 39-42, wherein the second information comprises burst information indicating at least two data packets belonging to a same burst.

Item 44. The network node according to any of items 39-43, wherein the second information comprises priority information.

Item 45. The network node according to item 44, wherein the priority information is indicative of a priority order between at least two data packets of the plurality of data packets.

Item 46. The network node according to any of items 44-45, wherein the priority information is indicative of a priority order of the wireless device in a group of wireless devices.

Item 47. The network node according to any of items 39-46, wherein the processor circuitry is configured to receive, from the wireless device, data from the buffer using the resource indicated in the control signalling.

Item 48. The network node according to any of items 39-47, wherein the control signalling indicative of the allocation of the resource for uplink transmission of the data comprises a resource grant indicative of the resource allocated for the uplink transmission of the data.

Item 49. The network node according to any of items 39-48, wherein the processor circuitry is configured to allocate, based on the buffer status report, the resource.

Item 50. The network node according to any of items 39-49, the processor circuitry is configured to schedule, based on the buffer status report, one or more uplink occasions.

The use of the terms “first”, “second”, “third” and “fourth”, “primary”, “secondary

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries or operations which are illustrated with a solid line and some circuitries or operations which are illustrated with a dashed line. Circuitries or operations which are comprised in a solid line are circuitries or operations which are comprised in the broadest example. Circuitries or operations which are comprised in a dashed line are examples which may be comprised in, or a part of, or are further circuitries or operations which may be taken in addition to circuitries or operations of the solid line examples. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a wireless device, for uplink transmission to a network node, the method comprising:
transmitting, to the network node, a buffer status report comprising first information indicative of an amount of data in a buffer of the wireless device;
wherein the buffer status report comprises second information further qualifying the data in the buffer; and
receiving, from the network node, control signalling indicative of an allocation of a resource for uplink transmission of the data;
wherein the second information comprises burst information indicating at least two data packets belonging to a same burst.

2. The method according to claim 1, wherein the second information comprises time information associated with at least one data packet in the buffer.

3. The method according to claim 2, wherein the time information is indicative of an age of the at least one data packet and/or an expiry of the at least one data packet.

4. The method according to claim 1, wherein the buffer comprises a plurality of data packets, and wherein the second information is indicative of a relation between at least two data packets of the plurality of data packets.

5. (canceled)

6. The method according to claim 1, wherein the second information comprises priority information.

7. The method according to claim 6, wherein the priority information is indicative of a priority order between at least two data packets.

8. The method according to claim 6, wherein the priority information is indicative of a priority order of the wireless device in a group of wireless devices.

9. The method according to claim 1, the method comprising transmitting, to the network node, data from the buffer using the resource indicated in the control signalling.

10. The method according to claim 1, the method comprising generating the buffer status report based on an analysis of the data in the buffer and/or additional information from an upper layer.

11. The method according to claim 1, wherein the receiving of the control signalling indicative of the allocation of the resource is performed after the transmission of the buffer status report.

12. The method according to claim 1, wherein the control signalling indicative of the allocation of the resource is based on the transmitted buffer status report.

13. The method according to claim 1, wherein the control signalling indicative of the allocation of the resource comprises a resource grant indicative of the allocation of the resource for the uplink transmission of the data.

14. A method, performed by a network node, for uplink scheduling, the method comprising:
receiving, from a wireless device, a buffer status report comprising first information indicative of an amount of data in a buffer of the wireless device, wherein the buffer status report comprises second information further qualifying the data in the buffer; and
transmitting, based on the buffer status report, control signalling indicative of an allocation of a resource for uplink transmission of the data.

15. The method according to claim 14, wherein the second information comprises time information associated with at least one data packet in the buffer.

16. The method according to claim 15, wherein the time information is indicative of an age of the at least one data packet and/or an expiry of the at least one data packet.

17. The method according to claim 14, wherein the buffer comprises a plurality of data packets, and wherein the second information is indicative of a relation between at least two data packets of the plurality of data packets.

18. The method according to claim 14, wherein the second information comprises burst information indicating at least two data packets belonging to a same burst.

19. The method according to claim 14, wherein the second information comprises priority information.

20. The method according to claim 19, wherein the priority information is indicative of a priority order between at least two data packets of the plurality of data packets.

21. The method according to claim 19, wherein the priority information is indicative of a priority order of the wireless device in a group of wireless devices.

22-50. (canceled)
